(19) United States
(12) Patent Application Publication
(10) Pub. No.: US 2011/0008645 A1
(43) Pub. Date: Jan. 13, 2011

(54) PROCESS FOR COATING METALLIC SURFACES WITH A PASSIVATING AGENT, THE PASSIVATING AGENT AND ITS USE

(76) Inventors: Mark Andre Schneider, Friedrichsdorf (DE); Petra Grünberg, Frankfurt am Main (DE)

Correspondence Address: FULBRIGHT & JAWORSKI, LLP, 666 FIFTH AVE, NEW YORK, NY, 10103-3198, US

(21) Appl. No.: 12/921,640

(22) PCT Filed: Mar. 10, 2009
(86) PCT No.: PCT/EP09/52767

§ 371 Date: Sep. 9, 2010

(30) Foreign Application Priority Data
Mar. 11, 2008 (DE) 0 2008 000 600.9

(51) Int. Cl. B32B 15/20; C23C 22/17; C09D 1/00

(52) U.S. Cl. 428/640; 427/305; 106/287.17; 106/287.18

(57) ABSTRACT

The invention relates to a process for coating metal surfaces with an aqueous composition in the form of a solution or in the form of a dispersion, the composition comprising at least one phosphate, at least 3 g/l of at least one titanium or/and zirconium compound and at least one complexing agent, and also to corresponding aqueous compositions. The coatings prepared thereby have very good bare corrosion protection in the NSS salt spray test and in the condensation-water/constant-climate test

The invention relates to a process for coating metal surfaces with an aqueous composition which is different from a phosphating solution, to the aqueous composition and to the use thereof in the process according to the invention.

Phosphate coatings are widely used as anticorrosive layers, as a forming aid and as a primer for paints and other coatings. Especially when they are used to provide temporary protection, in particular during storage, and are then painted, for example, they are referred to as a pretreatment layer before painting. However, if no paint layer or organic coating of any other kind is applied to the phosphate coating, the term treatment or passivation is used instead of pretreatment. Such coatings are also referred to as conversion layers if at least one cation of the metal surface, that is to say of the surface of the metal part, dissolves out and is used for the layer structure.

Among the coating processes, the so-called no-rinse processes are of great importance in particular for the very rapid coating of continuously moving strips of at least one metal material. Such strips can be sheets of small or very large width. Usually directly after galvanisation, but optionally also after appropriate cleaning or degreasing and after rinsing with water or an aqueous medium, as well as optionally after activation of the metal surface, a phosphate coating is applied to the strips by wetting with a phosphating solution and is then dried. Rinsing of the phosphate coating after drying could impair it, in particular if the phosphate coating is not crystalline or is only partially crystalline.

In the past, such problems were avoided on an industrial scale by adding nickel to the phosphating solution so that it mostly had nickel contents in the range from 0.5 to 1.5 g/l. In the case of zinc-manganese-nickel phosphating, zinc contents in the range from 0.6 to 3.5 g/l and manganese contents in the range from 0.4 to 2.5 g/l were mostly chosen.

However, the high-quality phosphating solutions and phosphate layers have a considerable content of zinc, manganese and nickel. Nickel in particular is to be avoided because of its toxicity and noxiousness. In addition, the unavoidable heavy metal contents in the waste water, in the phosphate slurry and in the grinding dust are a problem. However, no processes are available for the treatment of strips that ensure a high degree of bare corrosion protection (corrosion protection without paint/primer layers) in particular in the case of zinc-rich metal surfaces.

Despite the comparatively high phosphate content, the compositions of the present application are not phosphating solutions and the coating process is not phosphation, because a phosphating solution:
1. for high-quality phosphate layers, for example in the case of zinc- or/and manganese-rich phosphating processes, requires prior activation, for example based on titanium phosphate particles or zinc phosphate particles, so that a high-quality phosphate layer can be formed thereon,
2. can generally be used, in the case of zinc-containing phosphations, only in a pH range from 2 to 3.5,
3. does not usually withstand a total content of titanium or/and zirconium compounds of more than 0.05 or more than 0.1 g/l without problems, because titanium and zirconium compounds for phosphation are known to be bath poisons,
4. in practice never comprises a substantial content of silanes/silanols/siloxanes/-polysiloxanes,
5. rarely comprises a small content of a complexing agent, because this is in some cases considered to be a bath poison,
6. usually comprises in bath solutions a total content of cations in the range from 3.5 to 9.5 g/l and of phosphorus-containing compounds in the range from 5 to 20 g/l, calculated as PO₄,
7. often comprises an increased content of alkali and ammonium compounds, the pH value remaining in the range from 2.0 to 3.5 even with comparatively high contents of ammonium compounds,
8. where at least one complex fluoride is present, normally comprises only compounds based on boron or/and silicon complex fluoride,
9. in the phosphation of parts with a zinc- or/and manganese-rich phosphating solution, crystalline layers of often typical crystalline forms are usually formed at least in the treatment of individual parts, for example by immersion or/and spraying, and
10. in the case of bare corrosion protection, the crystalline zinc-phosphated surfaces exhibit a salt spray test on phosphated surfaces not treated with paint of typically only up to two hours without rust formation owing to the pores and the lack of closed texture, while the coatings according to the invention are usually resistant for at least two days in the salt spray test without additional paint treatment, without the coatings according to the invention being thicker than the comparable phosphatised coatings.

If, in very rare cases, a titanium or/and zirconium compound is used in a phosphating solution in a phosphating process, the total contents of such compounds are typically less than 0.2 g/l, because it is known that higher contents of such compounds usually lead to faults in the coating, in particular on aluminium-rich surfaces. Only very rarely is a complexing agent added to a phosphating solution. If in very rare cases a silane is used in a phosphating solution in a phosphating process, the contents are very small. However, a combination of these mentioned additives is never used in phosphation.

It has been found again and again that the behaviour of the aqueous compositions according to the invention and the properties of their coatings are so different compared with phosphating solutions and their phosphate layers that the term phosphation cannot be used in connection with the aqueous compositions according to the invention and their coating processes. Nevertheless, the process according to the invention is a conversion coating process of the first kind.

The object was, therefore, to propose a coating process with which the anticorrosive layer produced using an aqueous composition exhibits good corrosion protection (=bare corrosion protection), in particular on a metal strip, without coating with a paint/primer, because it should usually be possible for the steel manufacturer to process the coil further without rust deposits. In addition, good formability or/and also good alkali resistance during mildly alkaline cleaning or/and during forming with alkaline emulsions is/are advantageous for some embodiments. Where possible, the coating is optionally also to exhibit good corrosion protection after forming and also, where possible, good paint adhesion.

The object is achieved by a process for coating metal surfaces with an aqueous composition in the form of a solution or in the form of a dispersion, in which the composition comprises at least one phosphate, at least 3 g/l of at least one titanium or/and zirconium compound and at least one complexing agent.

The aqueous composition according to the invention will usually be a solution, provided that particles or/and an emulsion are not added, as long as the solution is stable and does not have a tendency to precipitate.

The term “additive” or “add” within the scope of this application means that such a substance or such a substance mixture is added at least once.

The composition according to the invention and the process according to the invention are used in particular for passivating the metal surface, but they can also be used for pretreatment prior to subsequent coating, for example with an organic coating, and for other purposes. Within the scope of this patent application, passivation is understood as meaning the coating of metal surfaces, in which a subsequent organic coating for providing permanent protection against corrosion is not normally applied. However, passivation does not rule out the subsequent application in some cases of at least one organic coating, such as, for example, a primer or even a paint system or/and an adhesive.

The aqueous composition according to the invention preferably comprises cations of aluminium, chromium(III), iron, manganese or/and zinc or/and at least one compound having a content of aluminium, chromium(III), iron, manganese or/and zinc. In a very large number of embodiments, the starting composition according to the invention, that is to say in particular the fresh concentrate or/and the fresh bath composition, but often also the replenishment solution which is added to the bath as required during use, in particular in order to keep the bath ready for use, preferably comprises a substantial content of cations or/and of at least one compound of aluminium, chromium(III), iron, manganese or/and zinc. In many embodiments, apart from the cations or/and compounds of aluminium, chromium, iron, manganese, titanium, zinc or/and zirconium, it does not comprise, or does not comprise a substantial content of, further heavy metal cations or/and heavy metal compounds in addition to those just mentioned. It often does not comprise a content of chromium either. However, the composition can often take up further cations or/and compounds by contact with the equipment, with the metal surfaces to be coated or/and by the introduction of impurities. The original chromium-free composition can therefore also comprise traces or occasionally even small contents of, for example, chromium or/and chromium compounds or/and cations/compounds of further steel stabilisers. The composition preferably comprises a total content of cations of aluminium, chromium(III), iron, manganese or/and zinc or/and of at least one compound having a content of aluminium, chromium(III), iron, manganese or/and zinc in the range from 1 to 100 g/l, calculated as metal. Most particularly preferably, these contents are in the range from 1.5 to 90, from 2 to 80, from 2.5 to 70, from 3 to 60, from 3.5 to 50, from 4 to 40, from 4.5 to 35, from 5 to 30, from 5.5 to 25, from 6 to 20 or from 8 to 14 g/l, calculated as metal. A content of chromium(III) as cations or/and compounds is particularly preferably zero, approximately zero or in the range from 0.01 to 30, from 0.1 to 20, from 0.3 to 12, from 0.5 to 8, from 0.8 to 6 or from 1 to 3 g/l, calculated as metal. The content of chromium(VI) as cations or/and compounds can be in particular zero, approximately zero or in the range from 0.01 to 8, from 0.05 to 5, from 0.1 to 3 or from 0.3 to 1 g/l, calculated as metal. Preferably at least 60%, at least 80%, at least 90% or even at least 95% of these cations and compounds are those based on aluminium or/and zinc. The content of such cations and compounds can be varied within a wide range. They can optionally be present in complexed form. It is also possible to take into account here that, owing to the pickling action, the main constituent of the metal surface, such as, for example, zinc in the case of galvanised surfaces, iron in the case of steel surfaces and aluminium in the case of aluminium surfaces, is added in smaller amounts with a relatively long throughput, because the main constituent replenishes itself owing to the pickling action. It is particularly preferred for the composition according to the invention to comprise substantially only cations of aluminium, iron, manganese, titanium, zinc or/and zirconium. Further types of cations here can optionally be in particular trace impurities, impurities that have been introduced or/and impurities extracted from devices or/and substrates by pickling.

In most embodiments, the content of cations or/and of at least one compound of alkaline-earth metals is approximately zero or in the range from 0.001 to 1.5 g/l, from 0.003 to 1 g/l, from 0.01 to 0.5 g/l or from 0.03 to 0.1 g/l, calculated as the particular metal in question. If the content of these cations/compounds is very low, no disadvantages are to be expected. If the content of these cations/compounds is too high, the stability of the solution is at risk and losses in terms of corrosion protection are to be expected. Contents of alkaline earth metal are usually a problem if they lead to precipitations. Owing to the contents of fluoride (including complex fluoride), precipitations with alkaline earth metal can readily occur. In most embodiments, the content of cations or/and of at least one compound of at least one alkali metal is approximately zero or in the range from 0.001 to 1.5, from 0.01 to 1, from 0.1 to 0.5, from 0.02 to 0.15 g/l, calculated as the particular metal in question. However, small alkali metal contents and alkaline-earth metal contents are in many cases not a problem if they are present in the order of magnitude of the contents of tap water.

The aqueous composition according to the invention preferably has a content of phosphate in the range from 1 to 400 g/l, calculated as PO₄. The phosphate content of the composition is particularly preferably in the range from 6 to 350, from 12 to 300, from 18 to 280, from 25 to 260, from 30 to 240, from 40 to 220, from 50 to 200, from 60 to 180, from 70 to 160, from 85 to 140 or from 100 to 120 g/l. If the content of phosphate is too low, the corrosion protection is low. A phosphate addition is preferably sufficiently high that a marked improvement in the corrosion protection and in the appearance of the surface is obtained. If the content of phosphate is too high, matt coatings can form. The ratio of Al:PO₄ in compositions in which the content of cations or/and inorganic compounds selected from those based on aluminium, chromium, iron, manganese or/and zinc is predominantly those based on aluminium, is preferably in the range from 1:10 to 1:25, in particular in the range from 1:12 to 1:18. The ratio of Zn:PO₄ in compositions in which the content of cations or/and inorganic compounds selected from those based on aluminium, chromium, iron, manganese or/and zinc is predominantly those based on zinc, is preferably in the range from 1:4 to 1:20, in particular in the range from 1:6 to 1:15. Phosphate is preferably added in the form of at least one compound selected from monophosphates (=orthophosphates based on PO₄³⁻, monohydrogen phosphates based on HPO₄²⁻, dihydrogen phosphates based on H₂PO₄⁻), diphosphates, triphosphates, phosphorus pentoxide or/and phosphoric acid (=orthophosphoric acid H₃PO₄). A phosphate addition can be a monometal phosphate addition, an addition of phosphoric acid and metal, of phosphoric acid and metal salt/metal oxide, of diphosphate, of triphosphate, of polyphosphate or/and of phosphorus pentoxide to water or to an aqueous mixture.

In the case of an addition, for example, of at least one orthophosphate, of at least one triphosphate or/and of phosphoric acid, a corresponding chemical equilibrium will be established in particular corresponding to the pH value and the concentrations of these additives. The more acidic the aqueous composition, the more readily the chemical equilibrium shifts towards orthophosphoric acid H₃PO₄, at higher pH values more readily towards tertiary phosphates based on PO₄³⁻. Within the scope of this application, many different orthophosphates can in principle be added. The orthophosphates of aluminium, chromium or/and zinc have been found to be particularly suitable. There is preferably added to the aqueous composition at least one orthophosphate with a total addition in the range from 1 to 400 g/l, calculated as PO₄, particularly preferably in the range from 5 to 300, from 10 to 250, from 15 to 200, from 20 to 150, from 25 to 100, from 30 to 80 or from 40 to 60 g/l. The total addition corresponds to the total content.

The aqueous composition can be prepared with phosphoric anhydride P₂O₅, with a phosphorus-containing acid, with at least one salt or/and ester of orthophosphoric acid or/and with at least one salt or/and ester of a condensed phosphoric acid, optionally together with at least one metal, carbonate, oxide, hydroxide or/and salt such as, for example, nitrate together with phosphoric acid.

The addition of at least one complexing agent can be advantageous or/and necessary if the pH value is to be raised, on dilution of the composition with water, on absorption of contents of ions or/and compounds, in particular of further ion types or/and further compounds, or/and to stabilise the composition, in particular in order to prevent or/and dissolve precipitations. It serves to keep dissolved in the solution an increased content of compounds, in particular of cations such as, for example, aluminium, chromium, iron, manganese, zinc or/and of cations that have been introduced, extracted from equipment by pickling or/and extracted from the metal surfaces by pickling, because precipitations such as, for example, of fluorides, oxides, hydroxides or/and phosphates, in particular of aluminium, iron, manganese or/and zinc, can be disruptive because slurries increasingly form. If a precipitation occurs, complexing agents can be added, if required, in order to dissolve the precipitation again. The at least one complexing agent serves in particular to complex cations such as, for example, aluminium, chromium, iron, magnesium, manganese, titanium, zinc or/and zirconium and thereby stabilise the solution or suspension, in particular at relatively low acidity. Moreover, an addition of at least one complexing agent has also been found to be more or less anticorrosive in many embodiments. If further complexing agent(s) is/are added or/and in the case of increased contents of complexing agent(s) in the aqueous composition, it can be advantageous also to add at least one approximately neutral or basic compound to the composition in order to establish a higher pH value. The term “complexing agent” within the scope of this application also includes chelating agents. There is then used as complexing agent in particular at least one compound based on alkoxide, carboxylic acid, phosphonic acid or/and complexing organic compound such as, for example, phytic acid or/and tannic acid. The higher the content of at least one complexing agent, the higher the pH value of the composition that can usually be established in dependence on the amount of cation. The content of complexing agent(s) can be varied within wide limits. The aqueous composition according to the invention preferably comprises a total content of at least one complexing agent in the range from 1 to 200 g/l. The total content of at least one complexing agent is particularly preferably in the range from 2 to 180, from 3 to 160, from 4 to 130, from 5 to 100, from 6 to 80, from 8 to 70, from 10 to 60, from 12 to 50, from 15 to 40 or from 20 to 30 g/l. The complexing agent content is preferably sufficiently high that the, composition is a stable solution and that stable solutions are optionally also obtained on dilution with water. If the content of complexing agent is too low, a rise in the pH value or/and an increase in the contents of cations or/and compounds can lead, depending on the amount of cations, to precipitations and accordingly optionally to precipitates and optionally to slurry formation. If the content of complexing agent is too high, the corrosion protection or/and the formability can be impaired.

In the process according to the invention there can preferably be added to the aqueous composition at least one phosphonic acid, at least one salt of a phosphonic acid or/and at least one ester of a phosphonic acid. The aqueous composition preferably comprises a content of at least one compound based on phosphonic acid in the range from 1 to 200 g/l, particularly preferably in the range from 0.3 to 150, from 1 to 80, from 1.5 to 50 or from 2 to 30 g/l. Particular preference is given to at least one compound based on phosphonic acid, such as, for example, diphosphonic acid, diphosphonic acid having an alkyl chain, for example 1-hydroxyethane-1,1-diphosphonic acid (HEDP), aminotris(methylenephosphonic acid) (ATMP), ethylenediamine-tetra(methylenephosphonic acid) (EDTMP), diethylenetriamine-penta-(methylenephosphonic acid) (DTPMP), diethylenetriamine-penta(methylenephosphonic acid) (DTPMP), hexamethylenediamine-tetra(methylenephosphonic acid) (HDTMP), hydroxyethyl-amino-di(methylenephosphonic acid) (HEMPA) or/and phosphonobutane-1,2,4-tricarboxylic acid (PBTC). These substances usually act as complexing agents.

In the process according to the invention, the composition preferably comprises in each case at least one carboxylic acid or/and a derivative thereof: for example, at least one compound based on formic acid, succinic acid, maleic acid, malonic acid, lactic acid, tartaric acid, citric acid or/and a chemically related hydroxycarboxylic acid or/and aminocarboxylic acid including the derivatives thereof. The at least one carboxylic acid can have a complexing or/and anticorrosive action. In some embodiments, the aqueous composition preferably comprises a content of at least one compound based on carboxylic acid in the range from 0.1 to 100 g/l, particularly preferably in the range from 0.3 to 80, from 1 to 60, from 1.5 to 45 or from 2 to 30 g/l.

The composition according to the invention preferably comprises at least one compound based on phytin or/and tannin. These include, inter alia, compounds such as, for example, phytic acid, tannic acid or/and derivatives thereof, such as, for example, their salts and esters including modified compounds thereof and their derivatives. Compounds having this chemical basis can often have a particularly positive effect on corrosion protection. They also act as complexing agents and are included in the complexing agents within the scope of this application. The composition of the tannin-based compounds in particular can vary considerably—for example depending on the natural raw materials that are used—and the purification or/and chemical modification thereof that has optionally been carried out. They are in some cases coloured. The aqueous composition preferably comprises at least one compound based on phytin or/and tannin, with a total content of such compounds in the range from 0.05 to 30 g/l, particularly preferably in the range from 0.3 to 25 g/l or from 1 to 20 g/l, most particularly preferably in the range from 1.5 to 15 g/l or from 2 to 10 g/l.

In the process according to the invention, the aqueous composition preferably comprises a total content of at least one titanium or/and zirconium compound of in each case at least 5 g/l, 10 g/l, 15 g/l, 20 g/l or 25 g/l. In particular, this total content is in the range from 3 to 200 g/l. It is frequently present as a content in the range from 1 to 100 g/l Ti or/and Zr, calculated as metal. It can optionally be added partially or wholly in the form of at least one complex fluoride or/and can be present in the aqueous composition partially or wholly in the form of at least one complex fluoride. Particularly preferably, the aqueous composition comprises a total content of at least one titanium or/and zirconium compound in the range from 1.5 to 200, from 2 to 160, from 3 to 130, from 4 to 100, from 5 to 80, from 6 to 60, from 8 to 50, from 10 to 40, from 15 to 30 or from 20 to 25 g/l. Particularly preferably, the content of Ti or/and Zr, calculated as metal, in the aqueous composition is in the range from 3 to 90, from 6 to 80, from 10 to 70, from 20 to 60 or from 35 to 50 g/l. In particular cases it is also possible to add as the titanium or/and zirconium compound at least one compound that is usually stable only in a basic medium but, with the addition also of at least one complexing agent, such as, for example, a phosphonate, or/and at least one protecting compound, such as, for example, a surfactant, is also stable in an acidic medium, this compound then being present in complexed or/and protected form in the aqueous composition. Particularly preferably there is added as the fluoride-containing compound only at least one titanium or/and zirconium compound based on complex fluoride. In many embodiments, the composition comprises in each case at least one complex fluoride or/and its salt of aluminium, titanium, zinc or/and zirconium, which are present approximately in the form of MeF₄ or/and MeF₆ complex. In the case of aluminium-containing metal surfaces in particular, it is important to add not too small an amount of complex fluoride in order to produce an increased pickling action. Particularly preferably, the aqueous composition comprises a content of at least one titanium or/and zirconium compound based on complex fluoride in the range from 1 to 200, from 1.5 to 175, from 2 to 150, from 3 to 120, from 4 to 100, from 5 to 80, from 6 to 60, from 8 to 50, from 10 to 40, from 15 to 30 or from 20 to 25 g/l. The addition and content of at least one titanium or/and zirconium compound is preferably sufficiently high that good bare corrosion protection and, if required, also good paint adhesion to the subsequent paint/primer coating is obtained. If the content of at least one titanium or/and zirconium compound is too high and if complexing agent(s) is/are present in an insufficient amount, instability of the bath and accordingly precipitations can readily occur, because a fluoride or complex fluoride can also act as a complexing agent. However, fluoride and complex fluoride are not regarded as complexing agents within the scope of this application. The addition and content of a titanium compound has been found to be advantageous in particular for improving the corrosion protection. The addition and content of a zirconium compound has been found to be advantageous in particular in the case of hot-dip galvanised surfaces for improving the paint adhesion. In many embodiments, the titanium or/and zirconium compound according to the invention can be on the one hand at least one corresponding complex fluoride or/and at least one complexed substance, such as, for example, at least one titanium chelate, in particular at least one titanium alkoxide, preference being given to the less reactive titanium or/and zirconium compounds. The weight ratio of silane/silanol/siloxane/polysiloxane to complex fluoride based on titanium or/and zirconium, calculated as added silane or/and polysiloxane or optionally converted on a molar basis to H₂TiF₆, is preferably less than 2:1, less than 1.5:1, less than 1:1 or less than 0.5:1.

In some embodiments, the composition according to the invention comprises at least one titanium- or/and zirconium-containing fluoride-free compound, such as, for example, a chelate. This compound can serve to introduce titanium or/and zirconium into the composition in a different form and is therefore a possible source of such a compound. Such a compound can markedly improve the corrosion protection and keep the aqueous composition stably in solution. The composition according to the invention preferably comprises a content of titanium or/and zirconium chelates in the range from 0.1 to 200 g/l, particularly preferably in the range from 1 to 150, from 3 to 110, from 5 to 90, from 7 to 70, from 10 to 50 or from 15 to 30 g/l. In particular, the content of such compounds is so chosen that there remains on the metal surface a content of titanium or/and zirconium in the range from 3 to 60 or from 5 to 45 mg/m², calculated as metal and determined by X-ray fluorescence. Such a compound is added in particular when no other titanium- or/and zirconium-containing compound is present in the composition according to the invention, because it is particularly advantageous for at least one titanium- or/and zirconium-containing compound to be present in the composition according to the invention. Dihydroxo-bis-(ammonium lactate) titanate in particular can be used as such a compound.

In the process according to the invention, the aqueous composition preferably does not comprise a fluoride content or comprises a content of free fluoride F_{free} in the range from 0.01 to 5 g/l or/and a content of total fluoride Fₜₒₜₐₗ in the range from 3 to 200 g/l. Particularly preferably, the composition comprises a content of free fluoride F_{free} in the range from 0.1 to 3.5, from 0.3 to 2 or from 0.5 to 1 g/l or/and a content of total fluoride Fₜₒₜₐₗ in the range from 3 to 180, from 5 to 140, from 8 to 110, from 10 to 90, from 12 to 75, from 15 to 60 or from 20 to 40 g/l. In many embodiments, no hydrofluoric acid, no monofluoride or/and no bifluoride is added to the composition according to the invention. A content of hydrofluoric acid, monofluoride or/and bifluoride can then form in the composition according to the invention only on account of the equilibrium conditions in small amounts from at least one complex fluoride or/and a derivative thereof. In some embodiments, hydrofluoric acid, monofluoride or/and bifluoride is/are added to the composition according to the invention with a total content of from 0.01 to 8 g/l, calculated as free fluoride F_{free}, in particular from 0.1 to 5 or from 0.5 to 3 g/l.

Within the scope of this invention, the term “silane” is also to include hydrolysis, condensation, polymerisation and reaction products thereof, that is to say in particular silanols, siloxanes and optionally polysiloxanes. The term “polysiloxane” is also to include the condensation, polymerisation and reaction products of polysiloxane.

In the process according to the invention, the composition in some embodiments does not comprise a content of at least one silane/silanol/siloxane/polysiloxane and in many embodiments it preferably comprises a content of at least one silane/silanol/siloxane/polysiloxane in the range from 0.1 to 200 g/l, calculated on the basis of silane or polysiloxane in the particular starting compound in question. Particularly preferably, it comprises a content of at least one compound based on at least one silane/silanol/siloxane/polysiloxane in the range from 0.5 to 180, from 1 to 160, from 2 to 140, from 3 to 120, from 4 to 100, from 5 to 90, from 6 to 80, from 8 to 70, from 10 to 60, from 12 to 50, from 15 to 40 or from 20 to 30 g/l, in each case calculated on the basis of silane or polysiloxane in the particular starting compound in question. If the content of silane/silanol/siloxane/polysiloxane is too low, the corrosion protection of the coating is impaired—in particular in the case of hot-dip galvanised surfaces. If the content of silane/silanol/siloxane/polysiloxane is too high, it can lead to instability of the solution and accordingly to precipitations or/and to incomplete wetting of the metal surface. An addition and a content of at least one surfactant can prevent problems in the case of high contents, but it can also impair the corrosion protection of the coating that is produced. Preferably, the addition and content of silanes/silanols/siloxanes/-polysiloxanes is sufficiently high that good bare corrosion protection and, for hot-dip galvanised surfaces, also good wettability is obtained. The addition and content of at least one silane/silanol/siloxane/polysiloxane, in particular when added as silane/-silanol/siloxane or/and as polysiloxane, often improves the corrosion protection markedly. In particular, at least one silane is added in most embodiments, while at least one polysiloxane is added in only some embodiments, either alone or in addition to at least one silane.

The composition preferably comprises in each case at least one silane/silanolkiloxane/polysiloxane, in particular based on alkoxysilane, alkylsilane, amidosilane, aminosilane, bis-silyl-silane, epoxysilane, fluorosilane, imidosilane, iminosilane, isocyanatosilane, (meth)acrylatosilane or/and vinylsilane. Of these silanes/silanols/siloxanes/polysiloxanes, those based on aminosilanes have proved to be particularly suitable in various embodiments; however, the other silanes/silanols/siloxanes mentioned here may also be of importance depending on the embodiment. In the case of the addition of silanes or/and derivatives thereof which are optionally present after further condensation in particular at a slightly elevated pH value, such as, for example, those based on silanes/silanols/siloxanes having at least one nitrogen-containing group, such as, for example, on the basis of in each case at least one amino group (=aminosilanes), amido group, imino group or/and imido group, or/and with the uptake of protons having at least one ammonium group, these silanes/silanols/siloxanes contribute towards raising the pH value. It is also possible in this manner to raise the pH value, for example, from original values in the range from 0.5 to 2 to values in the range from 1.5 to 4. Particular preference is given to a content of silanes/silanols/siloxanes having at least one nitrogen-containing group, such as, for example, in each case at least one amino group (=aminosilanes), amido group, imino group or/and imido group. The alkylsilanes can in particular be di-, tri- or/and tetra-functional. The alkylsilanes can in particular be without an organically functional side chain or can exhibit in particular a terminal nitrogen-containing group. The alkylsilanes can optionally be without a side chain, but they can also have at least one side chain having a chain length of up to ten carbon atoms. In some embodiments, the aqueous composition preferably comprises an addition and content of at least one compound based on at least one silane/silanol/siloxane/polysiloxane a) having at least one nitrogen-containing group, such as, for example, at least one amino group or ammonium group, b) based on bis-silane(s), c) based on epoxysilane(s), d) based on fluorosilane(s), e) based on isocyanatosilane(s), f) based on (meth)acrylatosilane(s), g) based on vinylsilane(s), h) based on alkoxysilanes or/and i) based on alkylsilane in each case in the range from 0.5 to 160 g/l, particularly preferably in the range from 1 to 120, from 2 to 80, from 3 to 50, from 5 to 35 or from 8 to 20 g/l. Particularly preferred silanes are 3-aminopropyltriethoxysilane or/and 3-aminopropyltrimethoxysilane (APS), N-[2-(aminoethyl)]-3-aminopropyltrimethoxysilane (AEAPS), methylsilane, butylsilane, epoxysilane or/and tetraethoxysilane (TEOS). In the case of some silanes/silanols/siloxanes/polysiloxanes, the formation of HF gas can occur at higher fluoride contents.

Depending on the nature and degree of the polymerisation, such as, for example, a condensation, siloxanes or/and polysiloxanes can also be formed here. Alternatively, it has been shown that the addition and content of at least one polysiloxane or also the addition of a combination based on silane and polysiloxane can also be advantageous.

In the process according to the invention, the composition preferably comprises at least one organic monomer/oligomer/polymer/copolymer. Within the scope of this application, the term copolymer also includes block copolymers or/and graft copolymers. The addition and content of at least one such organic compound, preferably based at least partially on (meth)acryl, epoxide, ethylene, polyester or/and urethane, is important in some embodiments in order to improve the corrosion protection, the paint adhesion, the formability, the friction or/and the absorption of oil-containing impurities from the oiled or/and contaminated metal surface. The latter often serves to avoid the cleaning of oiled or/and contaminated metal surfaces. It is hereby possible optionally to absorb a small amount of finishing agent from a finishing process, a small amount of slushing oil from an oiling for reasons of temporary rust prevention or/and a small amount of forming oil from a forming operation on a metal surface coated according to the invention. The aqueous composition preferably comprises a content of at least one organic monomer/oligomer/polymer/copolymer in the range from 0.1 to 180 g/l, particularly preferably in the range from 2 to 120, from 5 to 80, from 8 to 55 or from 12 to 30 g/l. The content of organic monomer/oligomer/polymer/copolymer is preferably sufficiently high that the formability is improved, the friction during forming being reduced in particular. The content of organic monomer/oligomer/polymer/copolymer is preferably sufficiently low that the stability of the aqueous composition is retained and a good surface appearance of the coating is ensured, so that in particular matt or/and streaked coatings are not formed.

The composition preferably comprises at least one organic monomer/oligomer/polymer/copolymer based on or/and having a content of (meth)acryl, epoxide, ethylene, polyester or/and urethane. The at least one constituent mentioned here can also be at least one constituent of copolymer(s). The aqueous composition preferably comprises a content of at least one organic monomer/oligomer/polymer/copolymer based on a) (meth)acryl, b) epoxide, c) ethylene, d) polyester or/and e) urethane in each case in the range from 0.5 to 80 g/l, particularly preferably in the range from 2 to 60, from 5 to 50, from 8 to 40 or from 15 to 30 g/l.

In the process according to the invention, the composition preferably comprises in each case at least one inorganic or/and organic compound in particle form. Organic particles can be present in particular as a constituent of organic polymer/copolymer. In some embodiments the aqueous composition preferably comprises a content of inorganic or/and organic particles in the range from 0.05 to 80 g/l, particularly preferably in the range from 0.3 to 50, from 1 to 30, from 1.5 to 15 or from 2 to 10 g/l.

The composition according to the invention preferably comprises at least one inorganic compound in particle form based on Al₂O₃, SiO₂, TiO₂, ZnO, ZrO₂ or/and anticorrosive particles having a mean particle diameter of less than 300 nm, measured under a scanning electron microscope. The inorganic particles, such as, for example, those based on Al₂O₃, SiO₂, TiO₂ or/and ZrO₂, often also act as particles having a barrier effect and optionally with binding to the metal surface. ZnO particles, for example, can have an anticorrosive action until their optional dissolution. The anticorrosive particles can in particular be those based on, for example, silicate, especially alkali silicate or/and alkaline earth silicate, but also based on phosphates, phosphosilicates, molybdates, etc. Anticorrosive particles can help to achieve an anticorrosive action in particular on account of their barrier function or/and the release of ions. The content of inorganic particles is preferably sufficiently low that disruptive friction still does not occur during forming. The content of inorganic particles is preferably sufficiently high that the particles exert a barrier function and increased corrosion protection is achieved.

In some embodiments, the composition according to the invention comprises at least one accelerator, such as, for example, at least one accelerator selected from the group consisting of accelerators based on chlorate, nitrite, nitrobenzenesulfonate, nitroguanidine, perborate and at least one other nitroorganic compound having oxidising properties, which are known from phosphation. Such compounds can also contribute to reducing or avoiding the formation of hydrogen gas at the interface with the metal surface. In some embodiments, the aqueous composition comprises at least one of those accelerators in the range from 0.05 to 30 g/l, particularly preferably in the range from 0.3 to 20, from 1 to 12, from 1.5 to 8 or from 2 to 5 g/l.

The composition according to the invention preferably comprises at least one additive, such as, for example, in each case at least one wetting agent, demulsifying agent, emulsifier, antifoam, corrosion inhibitor or/and wax. If required, it is possible to add at least one additive as is conventional and known in principle in the case of conversion coatings, passivations or paints/primers. The aqueous composition preferably comprises at least one additive with a total content of the additives in the range from 0.001 to 50 g/l, particularly preferably in the range from 0.01 to 30, from 0.1 to 10, from 0.5 to 6 or from 1 to 3 g/l.

The object is also achieved with an aqueous composition according to the main claim.

The object is further achieved with a coating prepared by the process according to the invention or/and with an aqueous composition according to the invention.

The composition according to the invention preferably comprises:
1 to 100 g/l of Al, Cr(III), Fe, Mn or/and Zn together,
5 to 400 g/l of phosphate as PO₄,
1 to 200 g/l of complexing agent,
1 to 100 g/l of Ti or/and Zr together, calculated as metal,
0.1 to 200 or approximately zero g/l of F from at least one fluorine compound (Fₜₒₜₐₗ) or/and
0.1 to 200 g/l of silicon compound(s),

and also optionally at least one of the further compounds mentioned in this application.

The aqueous composition particularly preferably comprises:
8 to 75 g/l of Al, Cr(III), Fe, Mn or/and Zn together,
40 to 280 g/l of phosphate as PO₄,
20 to 120 g/l of complexing agent,
3 to 60 g/l of Ti or/and Zn together, calculated as metal,
5 to 120 or approximately zero g/l of F from at least one fluorine compound (Fₜₒₜₐₗ) or/and
10 to 160 g/l of silicon compound(s),

and also optionally at least one of the further compounds mentioned in this application.

The indicated contents apply both to concentrates and to baths. In the case of baths, all the above-mentioned ranges can each be divided, for example, by a dilution factor of 4.

The weight ratio of (Al, Cr³⁺, Fe, Mn and Zn):(Ti and Zr) is preferably in the range from 0.1:1 to 3:1. This weight ratio is particularly preferably in the range from 0.5:1 to 2.5:1 or from 1:1 to 2:1.

In addition to the added contents in particular of aluminium, chromium(III), iron, manganese, titanium, zinc or/and zirconium, these and optionally also further cations can be contained in the composition according to the invention: on the one hand by introduction, for example, from previous baths, by impurities or/and by dissolution, for example, from tank and raw materials as well as from the surfaces to be coated, on the other hand by addition of further cations/compounds having a metal content, such as, for example, at least one alkali metal, molybdenum or/and vanadium.

In many embodiments, the aqueous composition in accordance with the invention is preferably free or substantially free of compounds based on carboxylic acid, acrylic acid, phenol, starch, chromium(VI) or/and based on further heavy metals, such as, for example, those based on chromium, molybdenum, nickel, vanadium or/and tungsten. In many embodiments, the aqueous composition in accordance with the invention is free or substantially free of compounds that are used as accelerators in phosphation, in particular of compounds based on chlorate, nitrite, nitroguanidine, peroxide or/and further N-containing accelerators.

The compositions in accordance with the invention are preferably free or substantially free of chromium(VI). However, some of the compositions in accordance with the invention can also be free or substantially free of chromium(III), in particular optionally free or substantially free of cations or/and compounds of chromium.

The aqueous composition preferably does not comprise calcium or/and magnesium or only comprises a content of calcium or/and magnesium of not more than 0.5 g/l, particularly preferably of not more than 0.15 g/l, or/and of at least one toxic or environmentally unfriendly heavy metal, such as, for example, chromium, of not more than 0.5 g/l, particularly preferably of not more than 0.15 g/l. In fluoride-free compositions, a certain or a higher content of calcium or/and magnesium can also be present.

The composition according to the invention preferably has a pH value approximately in the range from 0 to 10. The pH value is in particular in the range from 0.3 to 8, from 0.5 to 6, from 0.8 to 5, from 1 to 4 or from 2 to 3. Concentrates often have a pH value in the range from 0.3 to 3; baths often have a pH value in the range from 1.5 to 4. At the beginning of the work, at high concentrations or/and in systems that have not been neutralised, the pH value often has values of from 0.1 to 2, in many cases in the range from 0.3 to 1. By dilution with water or/and by addition of particular basic substances, such as, for example, ammonia, at least one less acidic or approximately neutral silicon-containing compound or/and at least one organic polymer/copolymer, the pH value can be raised to a range of from 1 to 10, in particular from 1.5 to 7, from 1.8 to 5 or from 2 to 3.5, which is often advantageous. As a result, the composition itself is less corrosive. In principle, with an increased content of at least one complexing agent, a pH value of the composition in the range from 2 to approximately 10 can also be adjusted, an increased amount of in each case at least one approximately neutral or/and basic compound then being added. For influencing the pH value it is possible to add in particular ammonia, at least one other basic and optionally nitrogen-containing compound, at least one basic carbonate-, hydroxide- or/and oxide-containing compound, at least one organic polymer/copolymer or/and at least one silane/silanol/siloxane/polysiloxane. For example, zinc oxide, manganese carbonate or/and substantially neutral or basic polymers or/and copolymers can be added. The content of approximately neutral or/and basic agents that help to adapt the pH value and are added predominantly or only for the purpose of adapting the pH value can preferably be zero or in the range from 0.05 to 100 g/l, particularly preferably in the range from 0.2 to 60, from 1 to 40, from 2 to 25, from 3 to 18 or from 4 to 12 g/l. On account of contents of fluoride or/and silane/polysiloxane, it can be advantageous to measure not with a glass electrode but to use pH indicator paper.

In the process according to the invention, the aqueous composition preferably has values of the free acid FA in the range from 2 to 25 points, values of total acid TA in the range from 20 to 45 points or/and values of total acid Fischer TAF in the range from 12 to 20 points. The acid value S for the ratio of FA:TA is preferably in the range from 0.1 to 0.6. The acid value S for the ratio FA:TAF is preferably in the range from 0.2 to 1.3. Particularly preferably, the values of the free acid FA are in the range from 6 to 16 points, the values of the total acid TA are in the range from 27 to 37 points or/and the values of the total acid Fischer TAF are in the range from 15 to 18 points. Particularly preferably, the acid value S for the ratio of FA:TA is in the range from 0.2 to 0.5 or/and the acid value S for the ratio FA:TAF is in the range from 0.35 to 1.0. These values apply for titrations at concentrations of 60 g/l of solid and active substances with the exception of ammonia contents.

An amount of 60 g of the aqueous composition to be analysed is first made up to 1 litre with water and thereby diluted. In order to determine the free acid, 10 ml of the composition are diluted to 100 ml with demineralised water and then titrated to the turning point with 0.1 M NaOH using a Titroprocessor and an electrode. The amount of 0.1 M NaOH consumed per 10 ml of the dilute composition gives the value of the free acid (FA) in points.

In order to determine the total content of phosphate ions, the titration solution, following the determination of the free acid and after addition of potassium oxalate solution, is titrated to the 2nd turning point with 0.1 M NaOH using a Titroprocessor and an electrode. The consumption of 0.1 M NaOH for 10 ml of the dilute composition corresponds to the total acid according to Fischer (TAF). If this value is multiplied by 0.71, this gives the total content of phosphate ions calculated as P₂O₅ (see W. Rausch: “Die Phosphatierung von Metalien”. Eugen G. Leuze-Verlag 1988, pp. 300 ff).

The so-called S value for the ratio FA:TA or FA:TAF is given by dividing the value of the free acid by the value of the total acid or total acid according to Fischer.

The total acid (TA) is the sum of the divalent cations that are present and of the free and bound phosphoric acids (the latter are phosphates). It is determined by the consumption of 0.1 molar sodium hydroxide solution using a Titroprocessor and an electrode. This consumption per 10 ml of the dilute composition corresponds to the point value of total acid.

Table 2 gives an overview of the measured results. The formulations have identical starting compositions in which only the pH value has been varied with a different amount of ammonia.

In order to prepare an aqueous composition, all or most of the compounds, which are also present in the solution in corresponding constituents, are preferably added to the aqueous concentrates in the form of additives. The composition of the bath is preferably prepared by diluting the aqueous concentrate with from 10 to 1000% of the solid and active substance content of the concentrate with water from the aqueous concentrate. However, a highly concentrated or/and undiluted solution or dispersion can in some embodiments also advantageously be used.

All metal materials can be coated with their metal surfaces. Metal surfaces of aluminium, iron, copper, magnesium, titanium, zinc, tin or/and their alloys are preferably coated, in particular zinc, steel, hot-dip galvanised (HDG), electrolytically galvanised, Galvalume®, Galfan® or/and Alusi® surfaces. The composition according to the invention has proved to be outstandingly suitable especially in the case of zinc-rich or/and aluminium-rich metal surfaces. For surfaces of iron and steel materials, compositions having a pH value in the range from 4 to 10, in particular of at least 5 or even of at least 7, are particularly recommended in order to avoid flash rusting. The metal components coated by the process according to the invention can be used in particular in motor vehicle construction, as architectural elements in the construction sector or in the manufacture of devices and machines, such as, for example, domestic appliances.

The coating prepared according to the invention can have a coating composition that varies within wide limits. In particular, it can be characterised in that it comprises:

Al, Fe, Cr, Mn or/and Zn together,

calculated as metal from 1 to 100 mg/m²,

Ti or/and Zr together, calculated as metal from 1 to 100 mg/m²,

Si compound(s), calculated as metal from 0.1 to 25 mg/m²,

or/and P₂O₅ from 3 to 400 mg/m².

The coating according to the invention particularly preferably comprises:

Al, Fe, Cr, Mn or/and Zn together,

calculated as metal from 10 to 70 mg/m²,

Ti or/and Zr together, calculated as metal from 10 to 70 mg/m²,

Si compound(s), calculated as metal from 1 to 15 mg/m²,

or/and P₂O₅ from 80 to 220 mg/m².

These contents can be determined by a method of X-ray fluorescent analysis on a cut coated metal sheet. The weight ratio of (Al, Cr³⁺, Fe, Mn and Zn):(Ti and Zr) of the coating composition can preferably be in the range from 0.5:1 to 1.8:1, particularly preferably in the range from 0.9:1 to 1.4:1.

The layer weight of the layer formed according to the invention can vary within wide limits. It can be in the range from 0.01 to 12, from 0.05 to 10, from 0.1 to 8, from 0.3 to 6, from 0.5 to 4 or from 0.8 to 2 g/m². In the case of coating in strip installations it can be in particular in the range from 10 to 1000 mg/m², preferably in the range from 30 to 800 or from 60 to 650 mg/m², particularly preferably in the range from 100 to 500 or from 130 to 400 mg/m², most particularly preferably in the range from 160 to 300 or from 200 to 250 mg/m². In the case of coating in strip installations, the total content of titanium or/and zirconium in the dry film is preferably in the range from 1 to 100 mg/m² of Ti or/and Zr, calculated as metal, particularly preferably in the range from 10 to 60 mg/m². The total content of titanium or/and zirconium can be measured by X-ray fluorescence, for example. The total content of silicon in the dry film in the case of coating in strip installations is preferably in the range from 1 to 80 mg/m² of Si, calculated as metal, particularly preferably in the range from 3 to 40 mg/m². The total content of P₂O₅ in the dry film in the case of coating in strip installations is preferably in the range from 30 to 400 mg/m² of P₂O₅, particularly preferably in the range from 60 to 300 mg/m².

The thickness of the coatings according to the invention in the case of coating in strip installations is often in the range from 0.01 to 5.0 μm, in particular in the range from 0.5 to 3.5, from 0.8 to 2.5 or from 1.0 to 2.0 μm. In the case of coating in strip installations, the thickness of the coating is often in the range from 0.01 to 1.2 μm, in particular in the range from 0.1 to 1.0, from 0.2 to 0.8 or from 0.3 to 0.6 μm.

The aqueous compositions according to the invention frequently have a concentration of solid and active substances (total concentration) in the range from 10 to 800 g/l. A concentrate can often have a total concentration in the range from 200 to 800 g/l, in particular from 400 to 750 g/l. If required, it can be diluted with water. A concentrate is preferably diluted by a factor in the range from 1.1 to 25, particularly preferably in the range from 1.5 to 16, from 2 to 10 or from 3 to 6. The content of solid and active substances to be established in the aqueous composition is dependent especially on the type of substrate to be coated, on the particular installation in question and on the wet film thickness determined by the installation.

In many embodiments, the composition according to the invention is used on a metal strip in coil coating processes. Many of the strip installations have a strip speed in the range from 10 to 200 m/min. The quicker the strip is moved, the quicker the reactions between the composition according to the invention and the metal surface must take place in order not to require excessively long installation sections. The reaction time between application of the composition and the complete drying thereof can be from a fraction of a second to approximately 60 seconds. In the case of the more rapid strip installations in particular, this can mean that the aqueous composition has too little reactivity and must therefore exhibit stronger acidity and a stronger pickling power. Its pH value is preferably in the range from 0.5 to 3.5 in the case of coil coating processes. The concentration of all solid and active substances in the aqueous composition for coating in strip installations is often in the range from 200 to 800 or from 300 to 650 g/l. The contents of individual components or additives are adapted according to the total contents. The aqueous composition is usually applied to the clean or cleaned metal strip by spraying and squeezing off as a wet film, which often has a wet film thickness in the range from 1 to 4 μm. In some cases, a chemcoater or rollcoater can be used for the application instead.

The wet film on metal strips is mostly dried (no-rinse process). Drying can preferably take place in a temperature range of from approximately room temperature to approximately 75° C. peak metal temperature (PMT). The composition according to the invention can be designed specifically for slow or rapid treatment in a strip installation, for example by a suitable concentration and suitable pH value. Thus, neither the wet film nor the dried film is rinsed with water, so that the cations and compounds extracted from the metal surface by pickling are not removed but are incorporated into the coating.

In the coating according to the invention of metal parts, such as, for example, sections of metal sheets, cast parts, moulded bodies and complex shaped parts, the reaction time from first contact with the composition until it is completely dried (no-rinse process) or until the constituents that are removable by rinsing with water are rinsed off (rinse process) is preferably from 0.5 to 10 minutes. Longer times are possible in principle. The concentration of all solid and active substances in the aqueous composition is often in the range from 10 to 300 or from 30 to 200 g/l. In the case of rinsed coatings in particular, it is sometimes recommended to treat the coatings with a post-rinsing solution because much is often removed on rinsing with water. Instead of a layer construction, it is also possible in the case of some compositions for substantially only a pickling effect or/and only a very thin coating to occur on contact with the composition according to the invention, so that, for example in the case of hot-dip galvanised surfaces, the zinc crystallisation pattern becomes discernible at zinc grain boundaries. This also illustrates the difference from a phosphation.

It was surprising that, in contrast to a phosphate layer, the coating according to the invention offers unusually strong bare corrosion protection, even when the coating according to the invention is often far thinner than a phosphate layer and also when it is chrome-free. The bare corrosion protection of the coatings according to the invention is often better by a time factor of at least 20 or 30 than that of comparable zinc-phosphated coatings.

It was surprising that the corrosion protection was not impaired by an increased content of ammonia in the composition according to the invention and was improved considerably, in particular on hot-dip galvanised surfaces, by a content of silane.

It was surprising that the composition according to the invention is an unusually stable solution with an increased content of complexing agent, even with very high contents of solid and active substances.

### EXAMPLES AND COMPARATIVE EXAMPLES

The Examples (E) and Comparative examples (CE) described hereinbelow are intended to explain the subject-matter of the invention in detail.

### Comparative Example CE 0

Hot-dip galvanised sheets were coated in a laboratory rollcoater with aqueous solutions that contained only an addition of zinc dihydrogen phosphate (60%) in the range from 40 to 100 g/l and a corresponding molar amount of orthophosphoric acid in demineralised water. Coatings having a layer weight of from 110 to 360 mg/m² P₂O₅ were obtained. In the neutral salt spray test (NSS test) according to DIN EN ISO 9227 (bare corrosion test), the coatings exhibited corrosion phenomena of from 1 to 5% by surface area after only about 1 hour and thick, white layers of zinc corrosion products over the entire surface after only 8 hours. In the condensation-water/constant-climate test according to DIN EN ISO 6270-2 (KK test), white rust of up to 10% by surface area was found after 2 days. Such coatings are unusable for any purpose in European industry.

### Example E 0 According to the Invention

In comparison therewith, an aqueous solution having an addition of zinc dihydrogen phosphate (60%) in the range from 40 to 60 g/l, with an addition of a corresponding molar amount of orthophosphoric acid, of 25 g/l of H₂TiF₆ (50%), of 6 g/l of γ-APS (γ-aminopropyltriethoxysilane) and with demineralised water as the remainder was used for coating hot-dip galvanised sheets by roll coating in the laboratory. Coatings of in each case approximately from 110 to 165 mg/m² P₂O₅, 36 mg/m² Ti and 6 mg/m² Si were obtained. In the neutral salt spray test (NSS test) according to DIN EN ISO 9227 (bare corrosion test), these coatings exhibited a corrosive attack of from 1 to 5% by surface area, based on the entire surface, only after 48 to 72 hours, although there was no chromium in the coating. For high demands in European industry, resistances in the NSS test of 2 days, rarely of 3 or 4 days, with corrosion phenomena ≦5% by surface area are nowadays required. Such bare corrosion resistance is usually achieved only with chromium-rich systems. With the process according to the invention, bare corrosion resistances of 2 to 5 days were achieved, the substrates and the compositions being varied. In the condensation-water/constant-climate test according to DIN EN ISO 6270-2 (KK test), the improvement compared with Comparative example CE 0 is markedly smaller, however, than in the neutral salt spray test (NSS test). Even after 10 days' KK test, no rust deposit had yet formed.

### Examples E 1 to E 44 According to the Invention and Comparative Examples CE 1 to CE 4

Aqueous compositions were mixed, the compositions of which are shown in Table 1 as concentrates. The dilution factor shows the dilution to the bath concentration used, that is to say from a concentrate to a bath, so that in the case of a concentrate 200 g, for example, were used and were diluted to 1000 g with water using a dilution factor of 5. Aluminium was used in the form of monoaluminium phosphate, chromium in the form of complexed chromium(III) fluoride or/and chromium(III) phosphonate, iron in the form of iron(III) nitrate hydrate, manganese in the form of manganese carbonate or/and manganese oxide, zinc in the form of monozinc phosphate or/and zinc oxide. As silanes there were added as No. 1) 3-aminopropyltriethoxysilane (APS), as No. 2) N-(2-aminoethyl)-3-aminopropyltrimethoxysilane (AEAPS) and as No. 3) tetraethoxysilane (TEOS). As complexing agents there were used as No. 1) 1-hydroxyethane-1,1-diphosphonic acid (HEDP) and as No. 2) phytic acid. As inhibitors there were added as No. 1) polymeric quaternary ammonium salt, as No. 2) quatemary ammonium salt, as No. 3) polyvinylpyrrolidone and as No. 4) tetraethanolamine. As titanium or/and zirconium compound there were added hexafluorotitanic acid, hexafluorozirconic acid or dihydroxo-bis-(ammonium lactate) titanate. As wax there was used a wax emulsion based on oxidised polyethylene. The pH value was adjusted, where appropriate, using aqueous ammonia solution. The ranges indicated for the pH value apply both to concentrates and to bath concentrations. When diluting the concentrates to prepare bath solutions, care was taken to ensure that no precipitates formed. The concentrates and bath solutions were stored at room temperature for from one to 24 hours before they were used.

There were then used in each case at least 9 sheets of hot-dip galvanised (HDG) steel in Examples E 1 to E 26 and E 36 to E 44 as well as in Comparative examples CE 1 to CE 4, sheets of Galvalume® (AZ) in Examples E 27 to E 32, sheets of Galfan® (ZA) in Example E 33 and sheets of Alusi® (AS) in Examples E 34 and E 35.

The sheets were pre-cleaned with a cloth in order largely to remove adherent anticorrosive oil and in order to achieve uniform distribution of the oil or other impurities. The sheets were then cleaned by spraying with a mildly alkaline, silicate-free powder cleaner until complete wettability with water was present. The duration for this was generally from 20 to 30 seconds. Rinsing with tap water by immersion was then carried out, followed by rinsing with tap water by spraying for 6 seconds and rinsing with demineralised water for 6 seconds. The majority of the adherent water was then removed from the sheets by squeezing between two rubber rollers. The sheets were then blown dry with oil-free compressed air.

The dry sheets were brought into contact with the aqueous composition at about 25° C. with the aid of a laboratory rollcoater. The pH value of the compositions was determined with pH indicator paper. A wet film having a thickness of approximately from 9 to 10 μm was applied. A dry film having a thickness of from 0.2 to 0.6 μm was produced by drying the wet film. To this end, the sheets so treated were dried at approximately 40 or 65° C. PMT. The edges of the coated sheets were then masked with commercial adhesive tape in order to rule out edge effects during the corrosion testing.

The coated sheets were then tested for their bare corrosion protection in the condensation-water/constant-climate test (KK test) according to DIN EN ISO 6270-2 and in the neutral salt spray test (NSS test) according to DIN EN ISO 9227. Evaluation was made visually. The indicated values for the corrosion correspond to the percentage surface area, which corresponds to the entire area (100%) accessible to chemical loading. In the case of Galvalume® sheets, “black rust” and “white rust” were evaluated in total. The results of the corrosion tests show the range of the corrosion protection, all the measured results, including measured values which are to be regarded as freak values, being used.

In Comparative examples CE 5 to CE 7, electrolytically galvanised sheets (ZE) were brought into contact with typical zinc-containing phosphating solutions after previous mildly alkaline cleaning, rinsing with tap water and titanium-phosphate-containing activation. The phosphation took place in Comparative examples CE 5 and CE 6 at temperatures in the range from room temperature to 40° C. by spraying and rinsing (rinse process), in Comparative example CE 7 at from 55 to 60° C. by rolling and drying (no-rinse process). The former were also oiled or subjected to post-rinsing.

TABLE 1
Overview of the compositions of the solutions used and their composition as
well as the properties of coatings prepared therewith as well as corresponding
compositions for comparison

| Contents in g/l | E1 | E2 | E3 | E4 | E5 | E6 | E7 | E8 | E9 | E10 |
|---|---|---|---|---|---|---|---|---|---|---|
| Substrate | HDG | HDG | HDG | HDG | HDG | HDG | HDG | HDG | HDG | HDG |
| Zn | 6.4 | 12.8 | 12.8 | 19.1 | 19.1 | 19.1 | 12.8 | 12.8 | 57.1 | 57.1 |
| Al | 7.4 | 4.9 | 4.9 | 2.4 | 2.4 | 2.4 | — | — | — | — |
| PO₄ | 105.8 | 107.5 | 107.5 | 109.3 | 109.3 | 109.3 | 55.4 | 55.4 | 248.8 | 248.8 |
| P₂O₅ | 79.1 | 80.4 | 80.4 | 81.7 | 81.7 | 81.7 | 41.4 | 41.4 | 185.9 | 185.9 |
| H₂TiF₆ | 72.5 | 72.5 | 72.5 | 72.5 | 72.5 | 72.5 | 72.5 | 72.5 | 162.5 | 162.5 |
| Ti | 21.2 | 21.2 | 21.2 | 21.2 | 21.2 | 21.2 | 21.2 | 21.2 | 47.5 | 47.5 |
| Fₜₒₜₐₗ | 50.4 | 50.4 | 50.4 | 50.4 | 50.4 | 50.4 | 50.4 | 50.4 | 113.0 | 113.0 |
| Complexing agent No., g/l | 1) 69.6 | 1) 34.8 | 1) 69.6 | 1) 69.6 | 1) 34.8 | 1) 21.9 | 1) 34.8 | 1) 34.8 | 1) 78.0 | 1) 78.0 |
| Silane No., g/l | 1) 34.8 | 1) 34.8 | 1) 34.8 | 1) 34.8 | 1) 34.8 | 1) 34.8 | 1) 34.8 | 1) 34.8 | 1) 78.0 | 1) 156.0 |
| NH₃ | — | — | — | — | — | — | — | 17.4 | 45.6 | 35.1 |
| Dilution factor | 5 | 5 | 5 | 5 | 5 | 5 | 5 | 5 | 10 | 10 |
| pH value | 0.5-1 | 0.5-1 | 0.5-1 | 0.5-1 | 0.5-1 | 0.5-1 | 0.5-1 | 2.2-2.5 | 1.9-2.2 | 1.9-2.2 |
| Layer weight mg/m²: | | | | | | | | | | |
| Si | 6 | 6 | 6 | 6 | 6 | 6 | 6 | 6 | 6 | 12 |
| Ti | 37 | 39 | 36 | 37 | 36 | 36 | 37 | 34 | 34 | 33 |
| P₂O₅ | 225 | 190 | 220 | 220 | 175 | 155 | 96 | 100 | 170 | 165 |
| KK test 10 days | 0% | 0% | 0% | 0% | 0% | 0% | — | — | — | — |
| KK test 20 days | — | — | — | — | — | — | 70-90% | 5-15% | 0% | 0% |
| Salt spray test 3 days | <5-10% | <5-15% | 1-10% | <1-5% | <1-10% | <1-1% | — | — | — | <5-15% |
| Salt spray test 4 days | 5-10% | <5-20% | <5-10% | 1-10% | <1-15% | <1-<5% | 10-20% | <5-80% | <5-20% | — |
| Contents in g/l | E11 | E12 | E13 | E14 | E15 | E16 | E17 | E18 | E19 | E20 |
| Substrate | HDG | HDG | HDG | HDG | HDG | HDG | HDG | HDG | HDG | HDG |
| Zn | 57.1 | 25.5 | 38.2 | 25.5 | 25.5 | 25.5 | 25.5 | 25.5 | 25.5 | 25.5 |
| Mn | — | | | 5.6 | 4.2 | | | | | |
| PO₄ | 248.8 | 111.0 | 166.5 | 111.0 | 111.0 | 111.0 | 111.0 | 111.0 | 111.0 | 111.0 |
| P₂O₅ | 185.9 | 82.9 | 124.4 | 82.9 | 82.9 | 82.9 | 82.9 | 82.9 | 82.9 | 82.9 |
| H₂TiF₆ | 130 | 72.5 | 72.5 | 58.0 | 72.5 | | 72.5 | 72.5 | 72.5 | 72.5 |
| H₂ZrF₆ | — | | | | | 40.6 | | | | |
| Ti or Zr | 38.0 | 21.2 | 21.2 | 16.9 | 21.2 | 18.3 | 21.2 | 21.2 | 21.2 | 21.2 |
| Fₜₒₜₐₗ | 90.4 | 50.4 | 50.4 | 40.4 | 50.4 | 22.3 | 50.4 | 50.4 | 50.4 | 50.4 |
| Complexing agent No., g/l | — | 1) 34.8 | 1) 34.8 | 1) 17.4 | 1) 34.8 | 1) 34.8 | 1) 34.8 | 1) 34.8 | 1) 34.8 | 1) 34.8 |
| Complexing agent No., g/l | 2) 104.0 | | | 2) 46.4 | | | | | | |
| Silane No., g/l | 1) 52.0 | 3) 33.1 | 2. 34.8 | 1) 34.8 | 1) 34.8 | 1) 34.8 | 1) 34.8 | 1) 69.6 | 1) 69.6 | 1) 69.6 |
| NH₃ | | | | | | | | 17.4 | 17.4 | 17.4 |
| Corrosion inhibitor No., g/l | | | | | | | | 1) 116.0 | 2) 116.0 | 3) 116.0 |
| Dilution factor | 10 | 5 | 5 | 5 | 5 | 5 | 5 | 5 | 5 | 5 |
| pH value | 0.5-1 | 0.5-1 | 0.5-1 | ca. 1.5 | ca. 1.5 | 0.5-1 | 0.5-1 | 1.9-2.2 | 1.9-2.2 | 1.9-2.2 |
| Layer weight mg/m²: | | | | | | | | | | |
| Mn | | | | 44 | 35 | | | | | |
| Si | 4 | 6 | 6 | 6 | 6 | 6 | 6 | 14 | 19 | 12 |
| Ti or Zr | 28 | 34 | 36 | 28 | 35 | 33 | 36 | 37 | 50 | 36 |
| P₂O₅ | 186 | 160 | 295 | 196 | 166 | 144 | 164 | 194 | 260 | 190 |
| KK test 10 days | 0% | 1% | 0% | 0% | 0% | 1% | | | | |
| KK test 20 days | | | | | | | <1% | 0% | 0% | 0% |
| Salt spray test 3 days | 40-60% | 15-20% | — | | 5-10% | 70-100% | | | | |
| Salt spray test 4 days | | | 10-20% | 20-40% | 15-25% | | <5% | 0-<5% | 0-1% | 0-<5% |
| Contents in g/l | E 21 | E 22 | E 23 | E 24 | E 25 | E 26 | E 27 | E 28 | E 29 | E 30 |
| Substrate | HDG | HDG | HDG | HDG | HDG | HDG | AZ | AZ | AZ | AZ |
| Zn | 25.5 | 25.5 | 25.5 | 25.5 | 25.5 | | 25.5 | 38.2 | 38.2 | 25.5 |
| Mn | | | | | 13.8 | | | | | |
| Fe | | | | | | 13.0 | | | | |
| Cr | | | | 13.7 | 13.7 | | | | | — |
| PO₄ | 111.0 | 111.0 | 111.0 | 139.9 | 132.8 | 240.3 | 111.0 | 166.5 | 166.5 | 111.0 |
| P₂O₅ | 82.9 | 82.9 | 82.9 | 104.6 | 99.2 | 179.6 | 82.9 | 124.4 | 124.4 | 82.9 |
| H₂TiF₆ | 72.5 | 72.5 | 72.5 | 72.5 | 72.5 | 162.5 | 72.5 | 72.5 | 72.5 | 72.5 |
| Ti | 21.2 | 21.2 | 21.2 | 21.2 | 21.2 | 47.5 | 21.2 | 21.2 | 21.2 | 21.2 |
| Fₜₒₜₐₗ | 50.4 | 50.4 | 50.4 | 50.4 | 50.4 | 113.0 | 50.4 | 50.4 | 50.4 | 50.4 |
| Complexing agent no., g/l | 1) 34.8 | 1) 34.8 | 1) 34.8 | 1) 42.5 | 1) 34.8 | 1) 69.6 | 1) 34.8 | 1) 34.8 | 1) 34.8 | 1) 34.8 |
| Complexing agent No., g/l | | | | | | | | | 2) 34.8 | |
| Silane No., g/l | 1) 34.8 | 1) 69.6 | 1) 34.8 | 1) 69.6 | 1) 69.6 | 1) 78.0 | 1) 34.8 | 1) 69.6 | 1) 69.6 | |
| NH₃ | | 17.4 | 26.1 | 17.4 | 17.4 | | 21.8 | 20.9 | 21.8 | 23.1 |
| Wax | | | 17.4 | | | | | | | |
| Tannin | | 5.0 | | | | | | | | |
| Corrosion inhibitor No., g/l | 4) 111.0 | | | | | | | | | |
| Dilution factor | 5 | 5 | 5 | 5 | 5 | 10 | 5 | 5 | 5 | 5 |
| pH value | 1.9-2.2 | 1.9-2.2 | 2.2-2.5 | 1.9-2.2 | 1.9-2.2 | 0.5-1.0 | 1.9-2.2 | 1.9-2.2 | 1.9-2.2 | 1.9-2.2 |
| Layer weight mg/m²: | | | | | | | | | | |
| Si | 6 | 13 | 8 | 13 | 12 | 6 | 8 | 8 | 12 | |
| Ti | 33 | 32 | 41 | 38 | 37 | 42 | 42 | 40 | 38 | 37 |
| Cr | | | | 32 | 32 | | | | | |
| P₂O₅ | 154 | 168 | 205 | 235 | 210 | 175 | 150 | 255 | 290 | 180 |
| | E21 | E22 | E23 | E24 | E25 | E26 | E27 | E28 | E29 | E30 |
| KK test 10 days | — | — | — | — | — | 5-10% | — | — | — | — |
| KK test 20 days | 100% | 0-25% | <1-1% | 0% | 0% | — | 0% | 0% | 0% | 1-<5% |
| Salt spray test 3 days | <5-<10% | — | — | — | — | <5-40% | — | — | — | |
| Salt spray test 4 days | — | <1-<5% | 1-20% | — | — | — | — | — | — | <1% |
| Salt spray test 7 days | — | — | — | 0% | 0-<5% | — | <1-<5% | — | — | 1-5% |
| Salt spray test 10 days | — | — | — | 0% | 0-20% | — | — | <1-<5% | <1% | — |
| Contents in g/l | E 31 | E 32 | E 33 | E 34 | E 35 | E 36 | E 37 | E 38 | E 39 | E 40 |
| Substrate | AZ | AZ | ZA | Alusi | Alusi | HDG | HDG | HDG | HDG | HDG |
| Zn | 57.1 | 57.1 | 25.5 | 25.5 | 12.7 | 49.9 | 49.9 | 38.2 | 25.5 | 25.5 |
| PO₄ | 248.8 | 248.8 | 111.0 | 111.0 | 55.5 | 217.6 | 217.6 | 166.5 | 111.0 | 111.0 |
| P₂O₅ | 185.9 | 185.9 | 82.9 | 82.9 | 41.5 | 162.6 | 162.6 | 124.4 | 82.9 | 82.9 |
| H₂TiF₆ | 162.5 | 195.0 | 101.5 | 72.5 | 72.5 | 162.5 | 162.5 | 14.5 | 43.5 | 87.0 |
| Ti | 47.5 | 57.0 | 29.7 | 21.2 | 21.2 | 47.5 | 47.5 | 4.2 | 12.7 | 25.4 |
| Fₜₒₜₐₗ | 113.0 | 135.6 | 70.6 | 50.4 | 50.4 | 113.0 | 113.0 | 10.1 | 30.3 | 60.6 |
| Complexing agent No., g/1 | 1) 78.0 | 1) 78.0 | 1) 34.8 | 1) 34.8 | 1) 34.8 | 1) 117.0 | 1) 117.0 | 1) 34.8 | 1) 34.8 | 1) 34.8 |
| Silane No., g/l | — | — | 1) 69.6 | 1) 34.8 | 1) 34.8 | 1) 78.0 | — | 1) 34.8 | 1) 34.8 | 1) 34.8 |
| NH₃ | 51.8 | 62.0 | 23.5 | 26.1 | 21.8 | 52.7 | 59.7 | — | — | — |
| Dilution factor | 10 | 10 | 5 | 5 | 5 | 10 | 10 | 5 | 5 | 5 |
| pH value | 1.9-2.2 | 1.9-2.2 | 1.9-2.2 | 2.2-2.5 | 1.9-2.2 | 1.9-2.2 | 1.9-2.2 | 0.5-1 | 0.5-1 | 0.5-1 |
| Layer weight mg/m²: | | | | | | | | | | |
| Si | — | — | 13 | n.b. | n.b. | 6 | — | 6 | 6 | 6 |
| Ti | 35 | 36 | 48 | n.b. | n.b. | 35 | 35 | 6 | 20 | 42 |
| P₂O₅ | 168 | 185 | 170 | n.b. | n.b. | 180 | 180 | 185 | 158 | 160 |
| KK test 10 days | — | — | — | — | — | — | — | <5% | 0% | 0% |
| KK test 20 days | <5% | <5% | <1% | 0% | 0-15% | 15-25% | 0-1% | — | — | — |
| Salt spray test 3 days | — | — | — | 10-20% | 20-50% | <5-50% | 60-100% | 70-90% | — | <5-10% |
| Salt spray test 4 days | <1% | <1-1% | <5% | 20% | 20-50% | — | — | — | 15-40% | <5-15% |
| Salt spray test 7 days | <5-5% | <1-<5% | — | — | — | — | — | — | — | — |
| Contents in g/l | E 41 | E 42 | E 43 | E 44 | CE 1 | CE 2 | CE 3 | CE 4 | | |
| Substrate | HDG | HDG | HDG | HDG | HDG | HDG | HDG | HDG | | |
| Zn | 85.7 | 25.5 | — | — | 63.7 | 38.2 | 25.5 | 25.5 | | |
| Al | — | — | 9.85 | 9.85 | — | — | — | — | | |
| PO₄ | 373.1 | 111.0 | 104.0 | 104.0 | 231.2 | 166.5 | 111.0 | 111.0 | | |
| P₂O₅ | 278.9 | 82.9 | 77.7 | 77.7 | 172.8 | 124.4 | 82.9 | 82.9 | | |
| Ti chelate | — | 107.3 | — | — | — | — | — | — | | |
| H₂TiF₆ | 162.5 | — | 72.5 | 72.5 | — | 72.5 | 72.5 | 58.0 | | |
| Ti | 47.5 | 17.5 | 21.2 | 21.2 | — | 21.2 | 21.2 | 16.9 | | |
| Fₜₒₜₐₗ | 113.0 | — | 50.4 | 50.4 | — | 50.4 | 50.4 | 40.3 | | |
| Complexing agent No., g/l | 2) 104.0 | 1) 69.6 | 1) 69.6 | 1) 69.6 | 2) 69.6 | — | — | — | | |
| Complexing agent No., g/l | — | — | — | 2) 69.6 | — | — | — | — | | |
| Silane No., g/l | — | — | 1) 34.8 | 1) 34.8 | — | 1) 34.8 | — | — | | |
| Wetting agent | — | 0.3 | — | — | — | — | — | — | | |
| Dilution factor | 10 | 5 | 5 | 5 | 5 | 5 | 5 | 5 | | |
| pH value | 0.5-1 | ca. 2 | 0.5-1 | 0.5-1 | 0.5-1 | 0.5-1 | 0.5-1 | 0.5-1 | | |
| Layer weight mg/m²: | | | | | | | | | | |
| Si | — | — | 6 | 6 | — | 6 | — | — | | |
| Ti | 32 | 35 | 36 | 36 | — | 32 | 32 | 27 | | |
| P₂O₅ | 225 | 270 | 225 | 245 | 240 | 165 | 115 | 105 | | |
| KK test 10 days | 0% | — | 0% | 0% | <5% | 0% | 1% | 30% | | |
| KK test 20 days | — | <1% | — | — | — | — | — | — | | |
| Salt spray test 3 days | 10-40% | 10-30% | — | <5-10% | 100% | 5-10% | 10-30% | 60-70% | | |
| Salt spray test 4 days | — | — | <5-10% | — | — | — | — | — | | |
| Contents in g/l; zinc | CE 5 | CE 6 | CE 7** | | | | | | | |
| phosphations | | | | | | | | | | |
| Substrate | ZE | ZE | ZE | | | | | | | |
| Zn | 1.6 | 1.6 | 1.7 | | | | | | | |
| PO₄ | 18.1 | 18.1 | 10.3 | | | | | | | |
| P₂O₅ | 13.5 | 13.5 | 7.7 | | | | | | | |
| Ti, Zr, silane, polysiloxane | 0 | 0 | 0 | | | | | | | |
| in each case | | | | | | | | | | |
| Fₜₒₜₐₗ, complexing agent | 0 | 0 | 0 | | | | | | | |
| in each case | | | | | | | | | | |
| Mn | 1.9 | 1.9 | 0.85 | | | | | | | |
| Ni | 1.3 | 1.3 | 0.31 | | | | | | | |
| Layer weight g/m² | 1.8 | 1.8 | 0.3 | | | | | | | |
| After-treatment, post-rinsing | oiled | Zr rinsing | none | | | | | | | |
| Zr layer calculated as metal | — | 9 | — | | | | | | | |
| mg/m² | | | | | | | | | | |
| KK test 1 day | — | 1% WR | 40-50% WR | | | | | | | |
| KK test 2 days | — | <5%WR | — | | | | | | | |
| KK test 21 days | <1% WR | — | — | | | | | | | |
| Salt spray test 1 day | 5-10%WR | 20% WR | 100% WR | | | | | | | |
| Salt spray test 2 days | 20% WR | 50-60% WR | — | | | | | | | |
| Salt spray test 3 days | 40% WR | — | — | | | | | | | |

** = microphosphation
WR = white rust

TABLE 2
Examples of acidities in compositions based, for example, on E 10
with a reduced silane addition and measured after dilution to 60 g/l

| | A | B | C |
|---|---|---|---|
| pH value | ca. 0.5 | ca. 2 | ca. 3 |
| Free acid (FA) | 18.0 | 9.9 | 5.3 |
| Total acid (TA) | 38.8 | 31.5 | 25.6 |
| Total acid_{Fischer} (TAF) | 17.6 | 16.4 | 15.3 |
| S value (FA:TA) | 0.46 | 0.31 | 0.21 |
| S value (FA:TAF) | 1.02 | 0.60 | 0.35 |

The coatings prepared according to the invention exhibited a layer weight in the range from 350 to 650 mg/m² total coating and a layer thickness approximately in the range from 0.2 to 0.6 μm. They were so thin and were produced so quickly that the substances are not present in sufficiently crystalline form in the coatings that they can be determined by radioscopy. Scanning electron microscope photographs of these coatings substantially show the topography of the cleaned metal substrate surface. The applied coatings according to the invention are not shown significantly topographically under the scanning electron microscope. The coatings are evidently homogeneous transparent layers. Depending on the substrate type and coating, they render the metal surface slightly matt, equally as well as without a coating, or with a more pronounced gloss. In most cases the coatings do not have a tinge of colour.

In a further series, a powder coating based on polyester was applied in a layer thickness of approximately 80 μm to the hot-dip galvanised and pretreated sheets based on the composition of E 10. In the subsequent cross-cut test of the painted sheets according to DIN EN ISO 2409, a value of Gt 0 was always obtained before the corrosive action.

In each of Examples E 1 to E 6, the compositions comprise aluminium and zinc, the contents of which were varied. The KK test over 10 days on the associated coatings was without problems. In the case of Examples E7 to E 13, which comprise only zinc as cation, the PO₄ content, Ti content, pH value, type of complexing agent and type of silane in particular were varied. The corrosion protection can decrease at a lower phosphate content. Complexing agent 1) performed better than complexing agent 2). Silanes 1) and 2) performed slightly better than silane 3). In Examples E 14 and E 15, zinc and manganese were chosen as cations. It should be ensured in this connection that the manganese content does not impair the corrosion protection. In Examples E 16 and E 17, the addition of a titanium compound is compared with the addition of a zirconium compound. The addition of a titanium compound permits markedly higher corrosion protection on hot-dip galvanised surfaces. In Examples E 18 to E 21, various corrosion inhibitors were additionally used. The corrosion inhibitors improve the corrosion protection, corrosion inhibitor 4) having a slightly less protective action. The addition of tannin in Example E 22 did not bring about a significant improvement. In Examples E 23 to E 26, the additions of cations were varied. The addition of chromium(III) improved the corrosion protection very considerably. The use of only iron cations was less successful for the corrosion protection. In Examples E 27 to E 32 on Galvalume®, outstanding corrosion protection was found. A silane addition is not necessary for Galvalume® surfaces but is advantageous for a high degree of corrosion protection. Example E 33 demonstrates that good corrosion protection results can also be achieved on Galfan® surfaces. In Examples E 34 and E 35 for Alusi® surfaces, it must be ensured that the cation and phosphate content is not too low. In Examples E 36 to E 44, hot-dip galvanised surfaces were again coated. In Examples E 36 to E 41, the operation was carried out with or without silane and with varying contents of titanium compound. Better corrosion protection was obtained with the addition of silane or with an increased content of titanium compound. Complexing agent 1) usually performs better than complexing agent 2). Replacing titanium complex fluoride by a titanium chelate in Example E 42 resulted in outstanding corrosion protection for a silane-free and fluoride-free composition. In Examples E 43 and E 44, only aluminium was used as cation. The associated coatings appeared slightly matt. The corrosion protection was good.

The bare corrosion protection of the examples according to the invention, determined in the NSS test, is in most cases better by at least a time factor of 20 or 30 than that of comparable zinc-phosphated coatings. The main reason for this is assumed to be that the coating according to the invention is unusually closed and pore-free.

1-22. (canceled)

23. A process for coating and passivating metal surfaces with an aqueous composition in the form of a solution or in the form of a dispersion, wherein the composition contains
12 to 400 g/l of at least one phosphate,
3 to 200 g/l of at least one titanium or zirconium compound
1 to 200 g/l of at least one complexing agent, selected from the group of compounds based on phosphonic acid, phytin and tannin, wherein the content of compounds based on phosphonic acid amounts to 0 or 1 to 200 g/l, and wherein the content of compounds based on phytin or tannin amounts to 0 or 0.05 to 30 g/l, and also
3 to 100 g/l of cations of aluminum, chromium(III) or zinc or at least one compound having a content of aluminum, chromium(III) or zinc in the range from 1 to 100 g/l, calculated as metal, wherein the content of zinc is at least 3 g/l,
in that the composition has values of the free acid FA in the range from 2 to 25 points, values of total acid TA in the range from 20 to 45 points and values of total acid Fischer TAF in the range from 12 to 20 points, and
in that a wet film of the aqueous composition is dried on metal strips or sheets without the wet film or the dried film being rinsed with water.

24. A process according to claim 23, wherein the composition contains in addition cations of iron or manganese or at least one compound having a content of iron or manganese.

25. A process according to claim 24, wherein the composition contains a total content of cations of aluminum, chromium(III), iron, manganese or zinc or of at least one compound having a content of aluminum, chromium(III), iron, manganese or zinc in the range from 3 to 100 g/l, calculated as metal.

26. A process according to claim 23, wherein the composition substantially contains only cations of aluminum, iron, manganese, titanium, zinc or zirconium.

27. A process according to claim 23, wherein the composition contains a total content of at least one titanium or zirconium compound based on complex fluoride in the range from 1 to 200 g/l.

28. A process according to claim 23, wherein the composition contains a content of free fluoride F_{free} in the range from 0.01 to 5 g/l or a content of total fluoride Fₜₒₜₐₗ in the range from 3 to 180 g/l.

29. A process according to claim 23, wherein the composition contains at least one silane/silanol/siloxane/polysiloxane.

30. A process according to claim 29, wherein the composition contains a content of at least one silane/silanol/siloxane/polysiloxane in the range from 0.1 to 200 g/l, calculated on the basis of silane or polysiloxane in the particular starting compound in question.

31. A process according to claim 23, wherein the composition contains at least one additive such as, for example, in each case at least one wetting agent, demulsifying agent, emulsifier, antifoam, corrosion inhibitor or wax.

32. A process according to claim 23, wherein the composition has a pH value in the range from 0 to 10.

33. A process according to claim 23, wherein the metal surface treated with the aqueous composition is a metal surface based on aluminum, iron, magnesium, titanium, zinc or tin, in particular parts, strips or sheets.

34. A coating prepared by a process according to claim 23.

35. A metal component coated by the process according to claim 23.

36. A motor vehicle comprising the metal component of claim 35.

37. An architectural element comprising the metal component of claim 35.

38. A domestic appliance
